(19) United States
(12) Patent Application Publication
(10) Pub. No.: US 2004/0242268 A1
(43) Pub. Date: Dec. 2, 2004

(54) Wireless communications device having integral laser pointer

(76) Inventor: Chun-Yu Lee, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/858,747

(22) Filed: Jun. 1, 2004

(30) Foreign Application Priority Data
May 30, 2003 (TW) 92210058

(51) Int. Cl. H04M 1/00

(52) U.S. Cl. 455/556.1; 455/550.1

(57) ABSTRACT

A compact wireless communications device (100) integrating a laser pointer (40) includes a housing (10) containing conventional telephony circuitry and the laser pointer. The housing includes a printed circuit board and a user interface such as a display screen (20) and a plurality of keys (30). The laser pointer is housed in the housing and extends to one surface of the housing. The laser pointer includes a laser diode (41), an optical transmission device (42), and two focus lenses (43, 44). The first focus lens is mounted between the laser diode and one end of the optical transmission device. The second focus lens is mounted on an opposite end of the optical transmission device, and is located in said surface of the housing. The laser pointer is selectively coupled to a battery of the wireless communications device by using the display screen and one of the keys.

### BACKGROUND OF THE INVENTION

1. Field of the Invention

The present invention relates to a multi-function wireless communications device, and especially to a mobile phone having an integral laser pointer.

2. Description of the Related Art

The world is currently experiencing revolutionary changes in communications systems, brought about in large part by the general evolution of and accessibility to wireless telephony systems. It has been predicted that wireless telephony will eventually replace much of the existing landline telephony systems. If and when this occurs is likely to depend on the ability of wireless telephony systems to provide the features that subscribers have come to expect from landline systems.

The proliferation of wireless telephony devices has been accompanied by the advent of mobile computers, notebooks, laptops, personal digital assistants and many other electronic devices, many of which have become virtually indispensable to certain persons such as white collar professionals. For example, traveling sales people can create a multimedia presentation on an office computer and then present it to prospective customers using a laptop. Such presentations can also be projected onto a large screen using a portable video projector.

Another useful electronic tool is the laser pointer. Conventional laser pointers are housed in a pen-like device. Although such laser pointers are easy to carry, they are also easily lost or forgotten. Conventional laser pointers are powered by batteries, which may or may not be rechargeable. For environmental reasons, it is preferable to use rechargeable batteries. However, it is inconvenient and impractical to carry a special recharging device for the laser pointer, which is likely to be in addition to recharging devices needed for other electronic devices.

One attempt to solve this problem is disclosed in Taiwan Patent No. 088212350, which is incorporated herein by reference. In this patent, a laser pointer is integrated with a mobile phone. The mobile phone includes a housing and a battery, with the laser pointer integrated in the battery. The laser pointer is usable only when the battery is attached to the mobile phone. A switch is set in the battery for controlling emission of light from the laser pointer. Thus a user may readily carry the mobile phone having the laser pointer, the mobile phone being less likely to be lost or forgotten. However, the incorporation of the laser pointer in the battery increases a thickness and size of the battery and the mobile phone. In addition, the mobile phone is generally equipped with two batteries, one for current use and one fully charged as a standby. If the standby battery is the one that has the laser pointer, it is inconvenient to have to change the battery of the mobile phone. Alternatively, both batteries must be equipped with a laser pointer, which unduly increases costs.

Therefore, a wireless communications device integrating a laser pointer which overcomes the above-described problems is desired.

### SUMMARY OF THE INVENTION

Accordingly, an object of the present invention is to provide a wireless communications device integrating a laser pointer which is conveniently sizes, inexpensive and easy to operate.

To achieve the above object, a compact wireless communications device integrating a laser pointer is provided by the present invention. The wireless communications device comprises a housing containing conventional telephony elements and the laser pointer. The housing comprises a printed circuit board, a battery, and a user interface including a display screen and a plurality of keys. The laser pointer is housed within the housing and extends to one surface of the housing. The laser pointer comprises a laser diode, an optical transmission device, and two focus lenses. The first focus lens is mounted between the laser diode and one end of the optical transmission device. The second focus lens is mounted on an opposite end of the optical transmission device, and is located in said surface of the housing. The laser pointer is selectively coupled to the battery of the wireless communications device by using the display screen and one of the keys.

In an alternative embodiment, the laser pointer comprises an optical cable serving as the optical transmission device, two ferrules, and two focus lenses. The ferrules are respectively mounted on the opposite ends of the optical cable, for retaining and protecting the optical cable. One of the focus lenses is mounted in axial alignment between the laser diode and a proximate one of the ferrules. The other focus lens is mounted on the other ferrule, is located in said surface of the housing. The laser diode, the optical cable, the ferrules and the focus lenses are aligned along a single axis.

Other objects, advantages and novel features of the present invention will be apparent from the following detailed description of preferred embodiments thereof with reference to the attached drawings, in which:

### BRIEF DESCRIPTION OF THE DRAWINGS

FIG. 1 is an isometric view of a wireless communications device integrating a laser pointer in accordance with a first embodiment of the present invention;

FIG. 2 is a partially cut-away front elevation of the wireless communications device of FIG. 1, showing the laser pointer mounted therein; and

FIG. 3 is similar to FIG. 2, but showing a wireless communications device in accordance with a second embodiment the present invention.

### DETAILED DESCRIPTION OF THE PREFERRED EMBODIMENTS

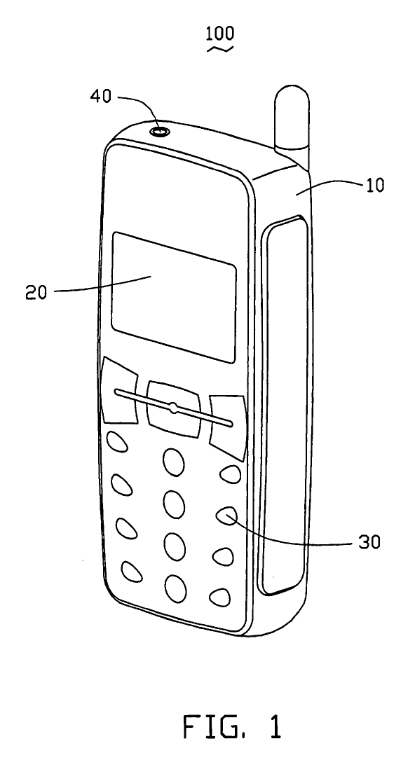

Referring to FIG. 1, illustrated is an isometric view of a mobile phone 100 having an integral laser pointer 40 in accordance with a first embodiment of the present invention. The mobile phone 100 includes a housing 10, a user interface (not labeled), and the laser pointer 40. The housing 10 receives conventional telephony elements such as a printed circuit board (not shown) and a battery (not shown). The battery provides electrical power for the mobile phone 100 and the laser pointer 40 to operate. The user interface includes a display 20 and a keypad 30 both located on a main surface of the housing 10. The laser pointer 40 extends along a longitudinal direction inside the housing 10 through to one end surface of the housing 10. The keypad 30 includes a plurality of keys, one of which is used to control switching of the laser pointer 40. When the laser pointer 40 is switched on, it projects a narrow beam of light that can illuminate a small spot on a remote surface.

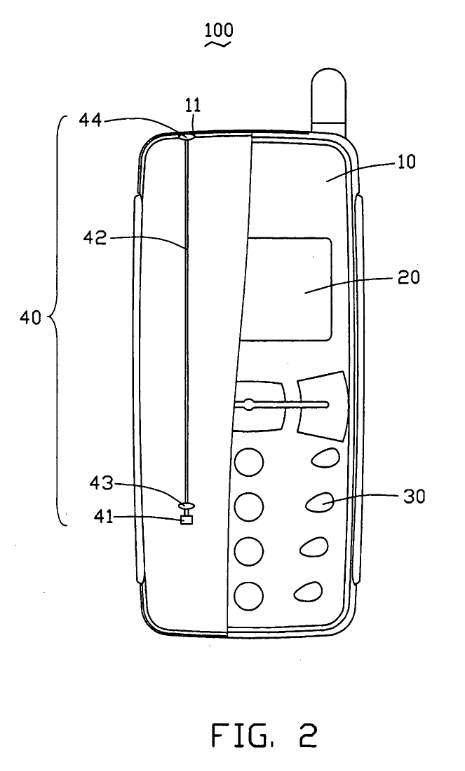

Referring to FIG. 2, illustrated is a schematic view of the laser pointer 40 housed within the housing 10 of the mobile phone 100. The laser pointer 40 includes a laser diode 41, an optical transmission device 42, and two focus lenses 43, 44. The laser diode 41 is mounted on the printed circuit board for receiving the electrical power from the battery. The optical transmission device 42 is made of flexible material, and is a long column. The focus lenses 43, 44 are made of resin or glass material. The focus lens 43 interconnects the laser diode 41 and one end of the optical transmission device 42. The focus lens 43 focuses light emitting from the laser diode 41 into the optical transmission device 42. The focus lens 44 is connected to an opposite end of the optical transmission device 42, and is mounted in an aperture 11 defined in a top surface of the housing 10. The laser diode 41, the optical transmission device 42 and the two focus lenses 43, 44 are aligned along a single axis. The focus lens 44 focuses and concentrates light received from the optical transmission device 42, and transmits the light out of the housing 10.

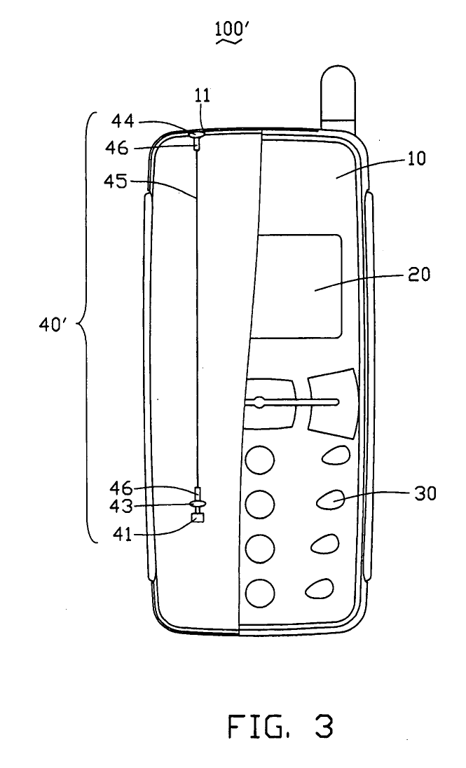

Referring to FIG. 3, illustrated is a schematic view of a laser pointer 40′ in accordance with a second embodiment of the present invention, the laser pointer 40′ being housed within the housing 10 of a mobile phone 100′. The laser pointer 40′ is similar to the laser pointer 40 of the first embodiment, and includes a laser diode 41, an optical cable 45, two focus lenses 43, 44, and two ferrules 46. The laser diode 41 is mounted on the printed circuit board (not shown) for receiving the electrical power from the battery (not shown). The optical cable 45 is made of flexible material. The ferrules 46 are made of ceramic material. The ferrules 46 retain and protect opposite ends of the optical cable 45 respectively. The focus lens 43 interconnects the laser diode 41 and a bottom one of the ferrules 46. The focus lens 43 focuses light emitted from the laser diode 41 into the optical cable 45 at said bottom ferrule 46. The focus lens 44 connects to a top one of the ferrules 46, and is mounted in the aperture 11 defined in the top surface of the housing 10. The laser diode 41, the optical cable 45, the ferrules 46, and the focus lenses 43, 44 are aligned along a single axis. The focus lens 44 focuses and concentrates light received from the optical cable 45 at said top ferrule 46, and transmits the light out of the housing 10.

In operation, the mobile phone 100 (100′) is switchable between a communication mode and a pointer mode. In the pointer mode, the laser pointer 40 (40′) is operated. Switching is accomplished by using the display 20 and the keypad 30, and controlling the keypad 30 to enable the battery to provide electrical power for the laser pointer 40 (40′). Upon enabling the laser pointer 40 (40′) with electrical power, the laser diode 41 emits a coherent beam of visible light, which transmits through the focus lens 43 and the optical transmission device 42 (ferrules 46, optical cable 45) to the focus lens 44. The focus lens 44 focuses and concentrates the beam of visible light, which is emitted out from the aperture 11 to illuminate a small spot of a remote surface.

The optical transmission device 42 and the optical cable 45 are both made of flexible material. Thus the location of the laser diode 41 on the printed circuit board, and the location of the aperture 11 in the housing 10 for the focus lens 44 can both be determined according to the arrangement of the conventional telephony elements. In particular, the optical transmission device 42 and the optical cable 45 can be bent and/or shortened or lengthened to suit almost any particular arrangement of conventional telephony elements required. That is, the optical transmission device 42 and the optical cable 45 provide great flexibility in the utilization of space within the housing 10 of the mobile phone 100 (100′). In particular, the size of the mobile phone 100 (100′) can be miniaturized. In addition, unlike conventional mobile phones, there is need for only a single laser pointer.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A wireless communications device, comprising:
a housing containing conventional telephony elements including a printed circuit board and a battery, a display and a keypad being mounted at a main surface of the housing;
a laser pointer housed within the housing and extending through one surface of the housing, the laser pointer comprising a laser diode, an optical transmission device, and two focus lenses, wherein one of the focus lenses is mounted between the laser diode and one end of the optical transmission device, and the other focus lens is mounted on an opposite end of the optical transmission device at said one surface of the housing;
whereby the battery provides electrical power for the laser diode to emit a substantially coherent beam of visible light, the focus lens at the laser diode focuses the visible light into the optical transmission device, and the focus lens at said one surface of the housing focuses and concentrates the beam of the visible light from the optical transmission device.

2. The wireless communications device as described in claim 1, wherein the optical transmission device is made of flexible material.

3. The wireless communications device as described in claim 1, wherein the laser diode, the optical transmission device, and the two focus lenses are arranged in a same axis.

4. The wireless communications device as described in claim 3, wherein said one surface of the housing defines an aperture receiving the focus lens thereat.

5. The wireless communications device as described in claim 1, wherein the focus lenses are made of resin or glass material.

6. The wireless communications device as described in claim 1, wherein the optical transmission device is an optical cable.

7. The wireless communications device as described in claim 6, wherein the laser pointer further comprises two ferrules respectively mounted on the opposite ends of the optical cable.

8. The wireless communications device as described in claim 7, wherein the ferrules are made of ceramic material.

9. The wireless communications device as described in claim 1, wherein the laser diode is disposed on the printed circuit board.

10. A laser pointer for use with a wireless communications device, the laser pointer comprising:
a laser diode adapted to emit a substantially coherent beam of visible light;
an optical transmission device for transmitting the visible light from the laser diode;
a first focus lens and a second focus lens;
wherein the first focus lens is mounted between the laser diode and an end of the optical transmission device, and the second focus lens is mounted on an opposite end of the optical transmission device.

11. The laser pointer as described in claim 10, wherein the first focus lens is disposed axially intermediate the laser diode and the optical transmission device, and the second focus lens is disposed in alignment with a central axis of the optical transmission device.

12. The laser pointer as described in claim 10, wherein the optical transmission device is made of flexible material.

13. The laser pointer as described in claim 10, wherein the focus lenses are made of resin or glass material.

14. The laser pointer as described in claim 10, wherein the optical transmission device is an optical cable.

15. The laser pointer as described in claim 14, wherein the laser pointer further comprises two ferrules respectively mounted on the opposite ends of the optical cable for protecting the optical cable.

16. The laser pointer as described in claim 15, wherein the ferrules are made of ceramic material.

17. The laser pointer as described in claim 10, further comprising a battery associated with said wireless communications device to providing electrical power for the laser pointer.

18. A wireless communication device comprising:
a housing containing conventional telephony elements including a printed circuit board and a battery, a display and a keypad being mounted at a main surface of the housing;
a laser pointer disposed within the housing while discrete from the battery, and extending through one surface of the housing, the laser pointer comprising a laser diode, an optical transmission device, and two lenses of which one is located in an interior of the housing closer to the laser diode and the other is located around a periphery of the housing far away from the laser diode; and
wherein the battery provides electrical power for the laser diode to emit a substantially coherent beam of visible light.
